(19) United States
(12) Patent Application Publication
(10) Pub. No.: US 2018/0290735 A1
(43) Pub. Date: Oct. 11, 2018

(54) VTOL HIGH SPEED AIRCRAFT

(71) Applicant: John Uptigrove, Rockyview (CA)

(72) Inventor: John Uptigrove, Rockyview (CA)

(21) Appl. No.: 15/480,397

(22) Filed: Apr. 6, 2017

(51) Int. Cl. B64C 27/14; B64C 29/00

(52) U.S. Cl. CPC B64C 27/14; B64C 29/0025

(57) ABSTRACT

A vertical take-off and landing high speed aircraft comprising a fuselage having a first and a second end; a first pair of wings positioned between the first and second end; a secondary pair of wings positioned at the second end, wherein the first and second pairs of wings are joined by a pair of booms, each boom of the pair of booms having an fore end and an aft end; a drive propeller positioned at the first or second end; and a plurality of lift rotors positioned at the fore and aft ends of the pair of booms, the plurality of lift rotors providing a lift force necessary for vertical take-off and landing.

### CROSS-REFERENCE TO RELATED APPLICATIONS

N/A

### BACKGROUND OF THE INVENTION

### 1. Field of the Invention

The present invention generally relates to a vertical take-off and landing flying vehicle, but more particularly to a vertical take-off and landing high speed aircraft.

### 2. Description of Related Art

There has always been a compromise between the ability of a helicopter to take off vertically without a landing strip, and the speed capabilities of an airplane. Helicopters are limited in how fast they can go because of their long rotating blades which move at different relative speeds. Indeed, the forward moving blade has a higher relative speed, while the rearward moving blade has a lower relative speed. As the helicopter moves faster, the forward moving blade approaches the speed of sound and becomes very inefficient, while the backward moving blade encounters what is known as retreating blade stall, meaning that it loses lift. For this reason, helicopters are limited to speed of about 140-180 mph. The military has tackled this problem by making vertical take-off and landing (VTOL) aircrafts, such as the Bell/Boeing V22 Osprey or the Sikorsky X-plane that use complex and very expensive methods to achieve both vertical and high speed flight. However, the advantages of aircrafts not requiring an airstrip are numerous and should not be just reserved for the military. Consequently, there is a need for a VTOL high speed aircraft for civilian use.

### BRIEF SUMMARY OF THE INVENTION

In one embodiment of the present invention, a vertical take-off and landing high speed aircraft is provided comprising a fuselage having a first and a second end; a first pair of wings positioned between the first and second end; a secondary pair of wings positioned at the second end, wherein the first and second pairs of wings are joined by a pair of booms, each boom of the pair of booms having a fore end and an aft end; a drive propeller positioned at the first or second end; and a plurality of lift rotors positioned at the fore and aft ends of the pair of booms, the plurality of lift rotors providing a lift force necessary for vertical take-off and landing.

In one embodiment, the fuselage includes a cockpit, an engine, a clutch, and a main gear box, wherein the engine is configured to provide power to the main gear box via the clutch. In one embodiment, two primary drive shafts are provided, wherein the power from the main gearbox is split into the two primary drive shafts. In another embodiment, the two primary drive shafts include proximal and distal ends and the two primary drive shafts are located inside the first pair of wings. In one embodiment, the proximal ends are attached to the main gearbox, and the distal ends connect to a pair of divider gear boxes.

In one embodiment, two secondary drive shafts located through the booms are provided, wherein the two secondary drive shafts are connect to a plurality of lift rotor gear boxes at each distal end of the two secondary drive shafts, wherein the plurality of lift rotor gear boxes are connected to the plurality of lift rotors. In another embodiment, the plurality of lift rotors are positioned and configured longitudinally along the pair of booms to reduce drag when the clutch is disengaged and the aircraft reaches a sufficient speed via the drive propeller such that the lift force via the first and second pairs of wings is maintained without the need of the plurality of lift rotors.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a perspective view of a VTOL high speed aircraft according to an embodiment of the present invention.

FIG. 2 is a partially transparent top view of a VTOL high speed aircraft according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide a VTOL high speed aircraft.

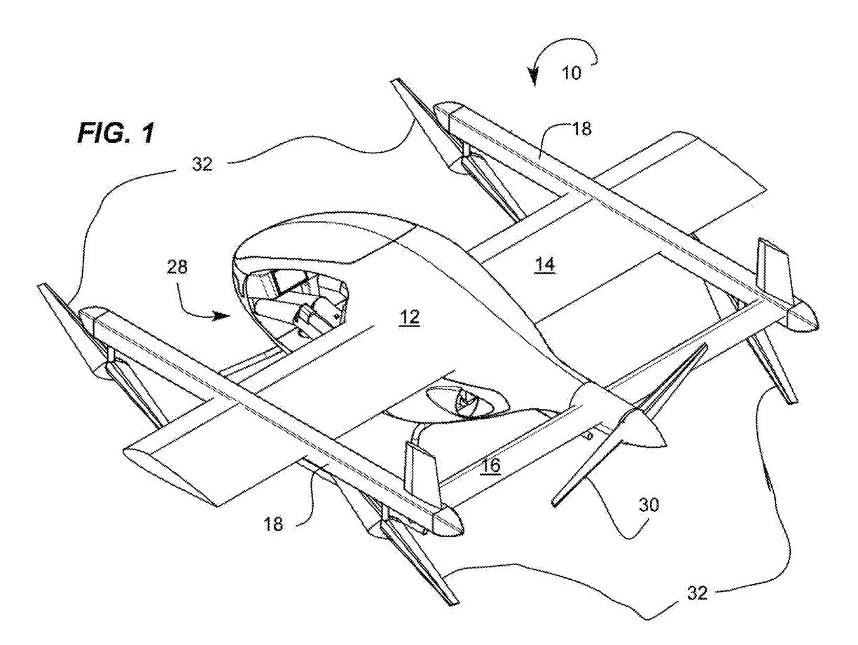

FIG. 1 is a perspective view of a VTOL high speed aircraft 10 according to an embodiment of the present invention. Referring now FIG. 1, the VTOL high speed aircraft comprises a fuselage, a first pair of wings 14, and a second pair of wings 16. The first pair of wings is the primary wings positioned approximately to the center of the fuselage, and the second pair of wings is the secondary wings forming the tail of the aircraft. The first and second pairs of wings are joined by a pair of booms 18.

In one embodiment, a drive propeller 30 is provided and attached to the fuselage. The drive propeller can be located either at the front end or the rear end of the fuselage, depending upon the airplane design. In one embodiment, lift rotors 32, preferably four, are held by the pair of wings and booms. The lift rotors provide the lift force necessary for take-off and landing.

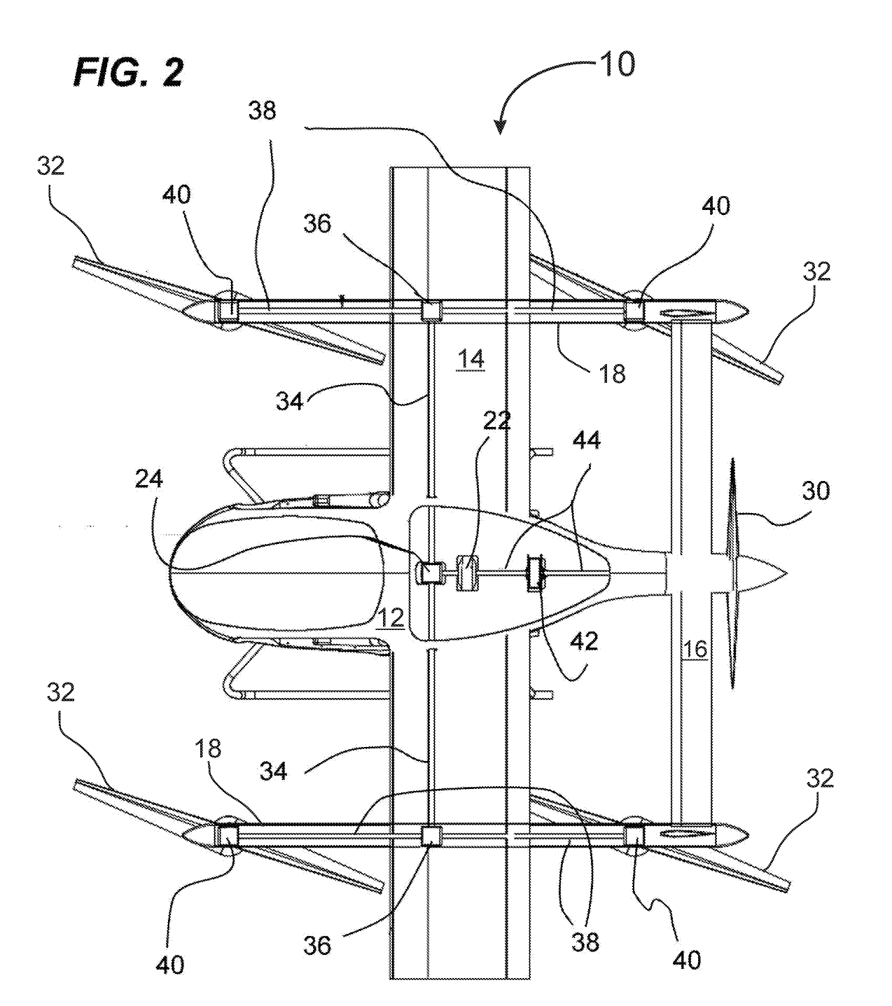

FIG. 2 is a partially transparent top view of a VTOL high speed aircraft 10 according to an embodiment of the present invention. Referring now FIG. 2, the VTOL high speed aircraft is illustrated. In one embodiment, the fuselage comprises an engine (not illustrated), a clutch 22, and a main gear box 24. The fuselage further comprises a cockpit 28 (FIG. 1) as well known in the art.

During operation, including both liftoffs and landings, the lift rotors provide lift force and are actuated by the engine via the clutch, which is then shifted to bring power to the main gearbox. Next, the power from the main gearbox is split into two primary drive shafts 34. The two primary drive shafts include proximal and distal ends and are located inside the first pair of wings. The proximal ends are attached to the main gearbox, and the distal ends connect to divider gear boxes 36. In one embodiment, two secondary drive shafts 38 located through the booms, are connected to lift rotor gear boxes 40 at each distal end of the two secondary drive shafts. The lift rotor gear boxes are connected to the lift rotors for operation, as well known in the art. In one embodiment, the engine connects to an engine shaft 44 via belts or gears 42, wherein the engine shaft connects to one end to the clutch and at the other end to the drive propeller.

In one embodiment, when the VTOL high speed aircraft achieves sufficient speed via the drive propeller maintaining lift from the wings, the clutch may be disengaged, wherein the lift rotors are positioned and configured longitudinally along the booms to reduce drag. In this embodiment and configuration, a much higher speed can be achieved than compared to a helicopter. This is a particular advantage of the present invention, as there are no horizontally rotating rotor blades creating drag, allowing the VTOL aircraft to configure and perform as a high speed fixed wing airplane.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention. For instance, the lift rotors can be driven with electric motors rather than through a system of shafts and gear boxes. The motors could then be turned off to stop the rotors for high speed flight.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A vertical take-off and landing high speed aircraft comprising:
a fuselage having a first and a second end;
a first pair of wings positioned between the first and second end;
a secondary pair of wings positioned at the second end wherein the first and second pairs of wings are joined by a pair of booms;
a pair of booms having a fore end and an aft end;
a drive propeller positioned at the first or second end; and
a plurality of lift rotors positioned at the fore and aft ends of the pair of booms, the plurality of lift rotors providing a lift force necessary for vertical take-off and landing.

2. The aircraft of claim 1, wherein the fuselage includes a cockpit, an engine, a clutch, and a main gear box, wherein the engine is configured to provide power to the main gear box via the clutch.

3. The aircraft of claim 2, further comprising two primary drive shafts, wherein the power flow the main gearbox is split into the two primary drive shafts.

4. The aircraft of claim 3, wherein the two primary drive shafts include proximal and distal ends and the two primary drive shafts are located inside the first pair of wings.

5. The aircraft of claim 4, wherein the proximal ends are attached to the main gearbox, and the distal ends connect to a pair of divider gear boxes.

6. The aircraft of claim 5, further comprising two secondary drive shafts located through the booms, wherein the two secondary drive shafts are connected to a plurality of lift rotor gear boxes at each distal end of the two secondary drive shafts, wherein the plurality of lift rotor gear boxes are connected to the plurality of lift rotors.

7. The aircraft of claim 6, wherein the plurality lift rotors of are positioned and configured longitudinally along the pair of booms to reduce drag when the clutch is disengaged and the aircraft reaches a sufficient speed via the drive propeller such that the lift force via the first and second pairs of wings is maintained without the need of the plurality of lift rotors.

8. The aircraft of claim 1 wherein the first and second pairs of wings are joined by the pair of booms.

9. The aircraft of claim 1 wherein the rotors are powered by electric motors.

10. The aircraft of claim 1 wherein the engine connects to an engine shaft via belts or gears.
